(19) United States
(12) Patent Application Publication
(10) Pub. No.: US 2011/0017670 A1
(43) Pub. Date: Jan. 27, 2011

(54) Silica Particles and Methods of Making and Using the Same

(76) Inventors: James M. Anderson, JR., Arlington Heights, IL (US); Dennis K. McCreary, Greencastle, PA (US); Surya Kiran L. Chodavarapu, Ellicott, MD (US); Paul B. Garms, Woodbury, MN (US)

Correspondence Address: W.R. GRACE & CO.-CONN., 7500 GRACE DRIVE, COLUMBIA, MD, 21044, US

(21) Appl. No.: 12/808,082

(22) PCT Filed: Dec. 9, 2008
(86) PCT No.: PCT/US08/13522

§ 371 Date: Oct. 1, 2010

Related U.S. Application Data
(60) Provisional application No. 61/007,270, filed on Dec. 12, 2007.
(60) Provisional application No. 61/126,467, filed on May 5, 2008.

(51) Int. Cl. B01J 20/10; B01D 15/08

(52) U.S. Cl. 210/656; 210/282; 428/402

(57) ABSTRACT

Metal oxide particles and compositions containing silica particles are disclosed. Methods of making silica particles and methods of using metal oxide particles are also disclosed.

### FIELD OF THE INVENTION

The present invention is directed to metal oxide particles, compositions containing metal oxide particles, methods of making metal oxide particles, and methods of using metal oxide particles.

### BACKGROUND OF THE INVENTION

In flash chromatography columns and high pressure liquid chromatography (HPLC) columns, the packing media is subjected to a relatively high packing pressure so as to provide a dense separation media. For example, packing pressures up to or greater than 1500 psi are typical packing pressures. During exposure to such high packing pressures, a portion of the packing media, for example, metal oxide particles, may break to form fines of particulate material. An increase in the amount of fines generated during a packing process can lead to a number of processing problems including, but not limited to, excess resistance to fluid flow through a column, non-uniform fluid flow through a column, and reduced column efficiency.

Efforts continue in the art to develop particles, such as metal oxide particles, having optimum properties so that the particles, once packed into chromatography columns or cartridges, provide increased efficiency, loading and resolution for various chromatographic applications, especially for flash chromatography.

There is a need in the art for metal oxide particles that are suitable for use in chromatography, which when used in a packed column or cartridge, and provide desirable column efficiency, sample loading, and sample resolution, especially for high pressure chromatographic applications.

### SUMMARY OF THE INVENTION

The present invention addresses some of the difficulties and problems discussed above by the discovery of new metal oxide particles. The metal oxide particles have a particle size and particle size distribution, which provides improved particle packing density and particle surface area within a packed column, while maintaining low column back pressure. Moreover, the particles possess a pore volume size and distribution that provide for desirable mass transfer to and from the metal oxide particles and the sample and/or eluant. The new metal oxide particles are particularly suitable for use in a flash chromatography column as chromatography media. The new metal oxide particles are typically very pure, porous, essentially macro-void free, amorphous metal oxide particles, and may be used as chromatographic media, without surface modification (i.e., unbonded or normal phase), or with surface modification (i.e., bonded or reverse phase, HIC, etc).

In one exemplary embodiment, a chromatography media of the present invention comprises porous metal oxide particles having, (i) a span value of about 1.5 or less, and (ii) a particle size distribution such that the median particle size is about 50 μm or less. The span value may be about 1.2 or less. The median particle size may range from about 30 to 50 μm.

In another exemplary embodiment, a chromatography media of the present invention comprises porous metal oxide particles having, (i) a span range of about 50 μm or less, and (ii) a particle size distribution such that the median particle size is less than about 50 μm. The span range may be about 40 μm or less. The median particle size may range from about 30 to 50 μm.

In one exemplary embodiment, the metal oxide particles of the present invention comprise porous metal oxide particles for use in flash chromatography comprising (i) a pore volume distribution of such that at least about 0.5 cc/g of the particles' pore volume is from pores having a pore size of 80 Å of less, and (ii) a particle size distribution such that the median particle size is less than about 50 μm. In an alternative exemplary embodiment, the particles may be treated to remove fines and ultrafines. In another embodiment, the metal oxide particles may be of high purity such that impurities comprise less than about 0.02 wt % based on the total weight of the particles.

The present invention is also directed to methods of making porous metal oxide particles for flash chromatography. In one exemplary method, the method of making porous metal oxide particles comprises forming the porous metal oxide particles; hydrothermally aging the porous particles; drying the porous particles; milling the porous particles; classifying the particles and treating the particles to remove ultrafines from the surface of the particles.

The present invention is further directed to methods of using metal oxide particles. In one exemplary method of using metal oxide particles, the method comprises a method of making a chromatography column comprising incorporating metal oxide particles into the chromatography column, the porous metal oxide particles comprising (i) a pore volume distribution of such that at least about 0.5 cc/g of the particles' pore volume is from pores having a pore size of 80 Å or less, and (ii) a particle size distribution such that the median particle size is less than about 50 μm. In an attending exemplary embodiment, the particles may be treated to remove fines and ultrafines. Further exemplary methods of using metal oxide particles may comprise using the above-described chromatography column to separate one or more materials from one another while passing through the chromatography column.

In another exemplary method of using metal oxide particles, the method comprises a method of making a chromatography column comprising incorporating metal oxide particles into the chromatography column, the porous metal oxide particles comprising a particle size distribution such that a median particle size is less than about 50 μm and a span value is about 1.5 or less. The span value may be about 1.2 or less. The median particle size may range from about 30 to 50 μm.

In a further exemplary method of using metal oxide particles, the method comprises a method of making a chromatography column comprising incorporating metal oxide particles into the chromatography column, the porous metal oxide particles comprising a particle size distribution such that a median particle size is less than about 50 μm and a particle size range d90-d12 is about 50 μm or less. The span range may be about 40 μm or less. The median particle size may range from about 30 to 50 μm.

The present invention is even further directed to chromatography columns, methods of making chromatography columns, and methods of using chromatography columns, wherein the chromatography column comprises porous metal oxide particles, the porous metal oxide particles comprising (i) a pore volume distribution of such that at least about 0.5 cc/g of the particles' pore volume is from pores having a pore size of 80 Å or less, and (ii) a particle size distribution such that the median particle size is less than about 50 μm. In an attending exemplary embodiment, the particles may be treated to remove fines and ultrafines.

In a further exemplary embodiment, the present invention is directed to chromatography columns, methods of making chromatography columns, and methods of using chromatography columns, wherein the chromatography column comprises porous metal oxide particles, the porous metal oxide particles comprising a particle size distribution such that a median particle size is less than about 50 μm and a span value is about 1.5 or less. The span value may be about 1.2 or less. The median particle size may range from about 30 to 50 μm.

In a further exemplary embodiment, the present invention is directed to chromatography columns, methods of making chromatography columns, and methods of using chromatography columns, wherein the chromatography column comprises porous metal oxide particles, the porous metal oxide particles comprising a particle size distribution such that a median particle size is less than about 50 μm and a particle size range d90-d12 is about 50 μm or less. The span range may be about 40 μm or less. The median particle size may range from about 30 to 50 μm.

These and other features and advantages of the present invention will become apparent after a review of the following detailed description of the disclosed embodiments and the appended claims.

### BRIEF DESCRIPTION OF THE FIGURES

FIG. 1A depicts a scanning electron microscope (SEM) image of exemplary silica particles of the present invention;

FIG. 1B depicts a scanning electron microscope (SEM) image of silica particles prior to the treatment according to the present invention;

FIG. 2 depicts pore volume distribution analysis of the exemplary silica particles of the present invention;

FIG. 3 depicts particle distribution analysis of the exemplary silica particles of the present invention;

FIG. 4 depicts chromatographs showing increased sample resolution using the exemplary silica particles of the present invention compared to conventional silica particles; and

FIG. 5 depicts chromatographs showing increased sample loading using the exemplary silica particles of the present invention compared to conventional silica particles.

FIG. 6 depicts particle size data identifying span and span range for the chromatographic particles of the present invention.

### DETAILED DESCRIPTION OF THE INVENTION

To promote an understanding of the principles of the present invention, descriptions of specific embodiments of the invention follow and specific language is used to describe the specific embodiments. It will nevertheless be understood that no limitation of the scope of the invention is intended by the use of specific language. Alterations, further modifications, and such further applications of the principles of the present invention discussed are contemplated as would normally occur to one ordinarily skilled in the art to which the invention pertains.

The present invention is directed to porous metal oxide particles. The present invention is further directed to methods of making porous metal oxide particles, as well as methods of using porous metal oxide particles. A description of exemplary porous metal oxide particles, methods of making porous metal oxide particles, and methods of using porous metal oxide particles are provided below.

It must be noted that as used herein and in the appended claims, the singular forms “a”, “and”, and “the” include plural referents unless the context clearly dictates otherwise. Thus, for example, reference to “an oxide” includes a plurality of such oxides and reference to “oxide” includes reference to one or more oxides and equivalents thereof known to those skilled in the art, and so forth.

“About” modifying, for example, the quantity of an ingredient in a composition, concentrations, volumes, process temperatures, process times, recoveries or yields, flow rates, and like values, and ranges thereof, employed in describing the embodiments of the disclosure, refers to variation in the numerical quantity that can occur, for example, through typical measuring and handling procedures; through inadvertent error in these procedures; through differences in the ingredients used to carry out the methods; and like proximate considerations. The term “about” also encompasses amounts that differ due to aging of a formulation with a particular initial concentration or mixture, and amounts that differ due to mixing or processing a formulation with a particular initial concentration or mixture. Whether modified by the term “about” the claims appended hereto include equivalents to these quantities.

As used herein, the term “bonded phase” means chromatography media (e.g. metal oxide particles) that have been surface modified by reaction with functional compound to alter selectivity of the media. For example, reacting metal oxide particles with octadecyltrichlorosilane forms a “reverse phase”. In another example, reaction of the metal oxide particles with aminopropyltrimethoxysilane followed by quaternization of the amino group forms an “anion exchange phase”. In a third example, a bonded phase may be formed by reaction of the metal oxide particles with aminopropyltrimethoxysilane followed by formation of an amide with an acid chloride. Other bonded phases include diol, cyano, cation, affinity, chiral, HILIC, etc.

As used herein, the term “flash chromatography” means the process passing a mixture dissolved in a mobile phase under pressure through a stationary phase (i.e., chromatography media) housed in a relatively large diameter column or cartridge, which separates the analyte to be measured from other molecules in the mixture and allows it to be isolated.

As used herein, the term “fines” means submicron sized particles.

As used herein, the term “impurities” means metal ions present in the metal oxide particles, which affect sample resolution when the particles are utilized in chromatography.

As used herein, the term “irregular” as it applies to the metal oxide particles means that the particle shape from one particle to the next is not uniform (i.e., random particle shape).

As used herein, “metal oxides” is defined as binary oxygen compounds where the metal is the cation and the oxide is the anion. The metals may also include metalloids. Metals include those elements on the left of the diagonal line drawn from boron to polonium on the periodic table. Metalloids or semi-metals include those elements that are on this line. Examples of metal oxides include silica, alumina, titania, zirconia, etc., and mixtures thereof.

As used herein, the term “pH modifier” means any chemical compound that, when dissolved in water, gives a solution with a hydrogen ion activity greater than in pure water, i.e. a pH less than 7.0.

As used herein, the term “sample loading capacity” means the maximum amount by weight of two compounds that can be injected into a chromatography cartridge and still maintain baseline line separation between the two compounds.

As used herein, the term “sample resolution” means resolution (r) between two peaks as defined by the equation:

r=(v2−v1)/0.5(w1+w2)

where v=elution volume, w=peak width (elution volume) at base, 1=peak 1, and 2=peak 2

As used herein, the term “bulk density” means the mass of many particles of material divided by the volume they occupy. The volume includes the space between particles as well as the space inside the pores of individual particles. The determination of bulk density (tamped) is carried out by tamping a sample of the test material in a compacting volume meter according to DIN EN ISO 787-11. 200 ml of sample are filled into a 250 ml measuring cylinder and weighed. The measuring cylinder is attached to the volume meter and the instrument, an Engelsmann Volumeter available from J. Engelsmann AG, switched on. The sample is tamped, not less than 5000 times, until the level of the material bed remains constant. The volume of the sample is then recorded and bulk density calculated by the following:

Bulk density[g/l]=weight of sample[g]/weight of sample[ml]×1000

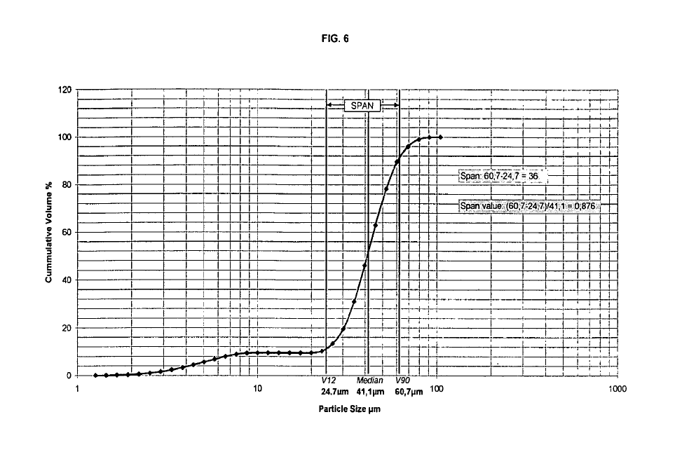

As used herein, the term “span” is defined as meaning a measure of the breadth of particle size distribution. The span (by volume) range is measured by subtracting the d₁₂ particle size (i.e., the particle size below which are 12% by volume of the particles) from the d₉₀ particle size (i.e., the size below which are 90% by volume of the particles) generated using transmission electron photomicrographs (TEM) particle size measurement methodologies. For example, TEM of abrasive particle samples were analyzed by conventional digital image analysis software to determine volume weighted median particle diameters and size distributions. The term “span value” is defined as the ratio of (d₉₀-d₁₂)/d₅₀ and is depicted in FIG. 6.

As used herein, the term “ultrafines” means very small or nano particles, including those less than 0.1 micron (100 nm) in size.

The metal oxide particles of the present invention have a physical structure and properties that enable the metal oxide particles to provide one or more advantages when compared to known metal oxide particles. The present invention addresses some of the difficulties and problems discussed above by the discovery of new metal oxide particles. The metal oxide particles have a particle size and particle size distribution, which provides improved particle packing density and particle surface area within a packed column, while maintaining low column back pressure. Moreover, the particles possess a pore volume size and distribution that provide for desirable mass transfer to and from the metal oxide particles and the sample and/or eluant. The new metal oxide particles are particularly suitable for use in a flash chromatography column as chromatography media. The new metal oxide particles are typically very pure, porous, essentially macro-void free, amorphous metal oxide particles, and may be used as chromatographic media, without surface modification (i.e., unbonded or normal phase), or with surface modification (i.e., bonded or reverse phase, HIC, etc). In one exemplary embodiment according to the present invention, the particles possess a particle size distribution and surface condition that provides significant advantages when utilized as chromatography media, especially as flash chromatography media.

In one exemplary embodiment, a chromatography media of the present invention comprises porous metal oxide particles having, (i) a span value of about 1.5 or less, and (ii) a particle size distribution such that the median particle size is about 50 μm or less. The span value may be about 1.4 or less, about 1.3 or less, about 1.2 or less, about 1.1 or less, or about 1.0 or less. The particle size distribution may be such that the median particle size is about 49 μm or less, about 48 μm or less, about 47 μm or less, 46 μm or less, 45 μm or less, 44 μm or less, 43 μm or less, 42 μm or less, 41 μm or less, 40 μm or less, 39 μm or less, 38 μm or less, 37 μm or less, 36 μm or less, 35 μm or less, 34 μm or less, 33 μm or less, 32 μm or less, 31 μm or less, 30 μm or less.

In another exemplary embodiment, a chromatography media of the present invention comprises porous metal oxide particles having, (i) a span of about 50 μm or less, and (ii) a particle size distribution such that the median particle size is less than about 50 μm. The span range may be about 49 μm or less, about 48 μm or less, about 47 μm or less, 46 μm or less, 45 μm or less, 44 μm or less, 43 μm or less, 42 μm or less, 41 μm or less, 40 μm or less, 39 μm or less, 38 μm or less, 37 μm or less, 36 μm or less, 35 μm or less, 34 μm or less, 33 μm or less, 32 μm or less, 31 μm or less, 30 μm or less. The particle size distribution may be such that the median particle size is about 49 μm or less, about 48 μm or less, about 47 μm or less, 46 μm or less, 45 μm or less, 44 μm or less, 43 μm or less, 42 μm or less, 41 μm or less, 40 μm or less, 39 μm or less, 38 μm or less, 37 μm or less, 36 μm or less, 35 μm or less, 34 μm or less, 33 μm or less, 32 μm or less, 31 μm or less, 30 μm or less.

In one exemplary embodiment, the metal oxide particles of the present invention comprise a porous metal oxide particle comprising (i) a pore volume distribution of such that at least about 0.5 cc/g of the particles' pore volume is from pores having a pore size of 80 Å of less, and (ii) a particle size distribution such that the median particle size is less than about 50 μm. In an attending exemplary embodiment, the particles may be treated to remove fines and ultrafines. The metal oxide particles may be of high purity such that impurities comprise less than about 0.02 wt % based on the total weight of the particles.

The metal oxide particles of the present invention have an irregular particle shape with a, median largest particle dimension (i.e., a largest diameter dimension). Typically, the metal oxide particles of the present invention have a median largest particle dimension of less than about 100 μm, more typically, less than about 50 μm. In one desired embodiment of the present invention, the metal oxide particles have a median largest particle dimension of from about 10 to about 50 μm, more desirably, from about 30 to about 50 μm.

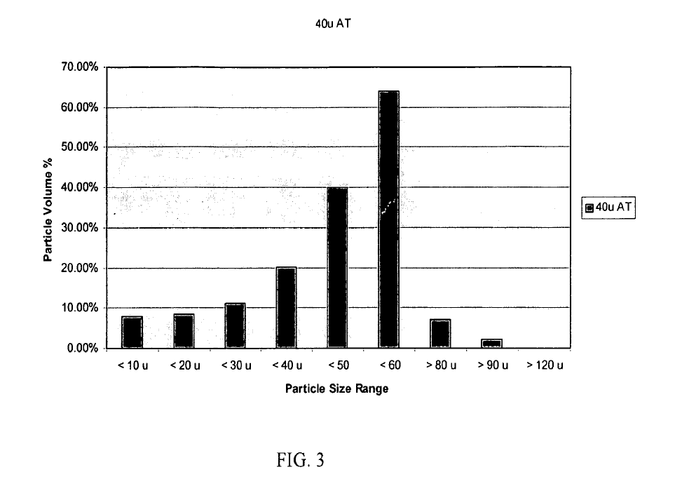

Preferred particle distributions are those where the metal oxide particles include median particle size, by volume, of about 20, 25, 30 or 35 μm to about 50, 55, 50 or 65 μm; a span value, by volume, of less than or equal to about 50, 55, 50, 45, 40 or 30 μm; and a fraction of particles greater than about 90 μm of less than or equal to 20, 15, 10, 5, 2, 1, or greater than 0 to 1% by volume of the metal oxide particles; and a fraction of particles less than about 10 μm of less than or equal to 20, 15, 10, 5, 2, 1, or greater than 0 to 1% by volume of the metal oxide particles. It is important to note that any of the amounts set forth herein with regard to the median particle size, span value, and fraction of particles above 100 μm and below 10 μm may be utilized in any combination to make up the metal oxide particles. For example, a suitable metal oxide particle distribution includes a median particle size, by volume, of about 35 μm to about 65 μm, a span value, by volume, of less than or equal to about 55 μm, a fraction of particles greater than about 90 μm less than or equal to about 10% by volume of the metal oxide particles; and a fraction of particles less than about 10 μm of less than or equal to 10% by volume of the metal oxide particles. A preferred metal oxide particle distribution includes a median particle size, by volume, of about 35 μm to about 65 μm, a span value, by volume, of less than or equal to about 50 μm, a fraction of particles greater than about 90 μm less than or equal to about 12% by volume of the metal oxide particles; and a fraction of particles less than about 10 μm of less than or equal to 12% by volume of the metal oxide particles. A more preferred metal oxide particle distribution includes a median particle size, by volume, of about 35 μm to about 65 μm, a span value, by volume, of less than or equal to about 45 μm, a fraction of particles greater than about 90 μm less than or equal to about 10% by volume of the metal oxide particles; and a fraction of particles less than about 10 μm of less than or equal to 10% by volume of the metal oxide particles. An even more preferred metal oxide particle distribution includes a median particle size, by volume, of about 35 μm to about 65 μm, a span value, by volume, of less than or equal to about 40 μm, a fraction of particles greater than about 90 μm less than or equal to about 12% by volume of the metal oxide particles; and a fraction of particles less than about 10 μm of less than or equal to 10% by volume of the metal oxide particles. As a result, the distribution has a relatively narrow span and yet a very small number of particles that are relatively large (e.g., above 100 μm) and relatively small (e.g., less than 10 μm). See FIG. 3.

Porous metal oxide particles of the present invention typically have an aspect ratio of less than about 1.4 as measured, for example, using Transmission Electron Microscopy (TEM) techniques. As used herein, the term “aspect ratio” is used to describe the ratio between (i) the average largest particle dimension of the metal oxide particles and (ii) the average largest cross-sectional particle dimension of the metal oxide particles, wherein the cross-sectional particle dimension is substantially perpendicular to the largest particle dimension of the metal oxide particle. In some embodiments of the present invention, the metal oxide particles have an aspect ratio of less than about 1.3 (or less than about 1.2, or less than about 1.1, or less than about 1.05). Typically, the metal oxide particles have an aspect ratio of from about 1.0 to about 1.2.

The porous metal oxide particles of the present invention also have a pore volume that makes the metal oxide particles desirable chromatography media. Typically, the metal oxide particles have a pore volume as measured by nitrogen porosimetry of at least about 0.40 cc/g. In one exemplary embodiment of the present invention, the porous metal oxide particles have a pore volume as measured by nitrogen porosimetry of from about 0.40 cc/g to about 1.4 cc/g. In another exemplary embodiment of the present invention, the porous metal oxide particles have a pore volume as measured by nitrogen porosimetry of from about 0.75 cc/g to about 1.1 cc/g.

Porous metal oxide particles of the present invention have an average pore diameter of at least about 30 Angstroms (Å). In one exemplary embodiment of the present invention, the metal oxide particles have an average pore diameter from about 40 Å to about 100 Å. In a further exemplary embodiment of the present invention, the metal oxide particles have an average pore diameter of from about 40 Å to about 80 Å. The pore volume of the particles may be measured by nitrogen porosimetry after the dispersion is dried. In general, at least about 0.5 cc/g of the particles' pore volume is from pores having a pore size of 80 Å of less. In exemplary embodiments according to the metal oxide particles of the present invention, at least 0.7 cc/g and 0.9 cc/g of pore volume are from pores having sizes less than 80 Å. In those embodiments, up to 95% of the pores have diameters less than 100 Å, and at least at least 80% and up to 95% of the pores of the metal oxide particles have diameters of 80 Å or less. The total pore volume of the particles is in the range of about 0.5 to about 2.0 cc/g, with embodiments comprising metal oxide particles having total pore volume measurements in the range of about 0.5 to about 1.5, and for certain metal oxide particle embodiments in the range of about 0.7 to about 1.2 cc/g. The pore volume for the dried particles is measured using BJH nitrogen porosimetry after the dispersion has been pH adjusted, slowly dried at 105° C. for at least sixteen hours and activated at 350° C. for two hours under vacuum.

The porous metal oxide particles of the present invention also have a surface area as measured by the BET nitrogen adsorption method (i.e., the Brunauer Emmet Teller method) of at least about 150 m²/g. In one exemplary embodiment of the present invention, the metal oxide particles have a BET surface area of from about 400 m²/g to about 700 m²/g. In a further exemplary embodiment of the present invention, the metal oxide particles have a BET surface area of from about 450 m²/g to about 500 m²/g.

In one embodiment of the present invention, the metal oxide particles may be of high purity such that impurities are quite low. For example, impurities including metal ions or compounds including the metal ions, such as iron, aluminum, sodium, chromium, cesium, copper, potassium, lithium, lanthanum, nickel, lead, phosphorus, manganese, molybdenum, calcium, titanium, vanadium, yttrium, zinc, magnesium may be less than about 0.05 wt %, preferably less than about 0.04 wt %, more preferably less than about 0.03 wt %, and even more preferably less than about 0.02 wt % based on the total weight of the particles.

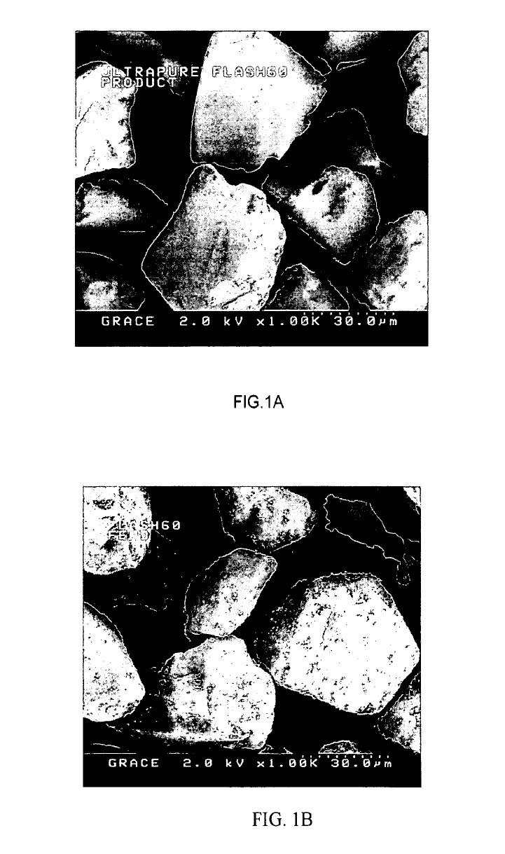

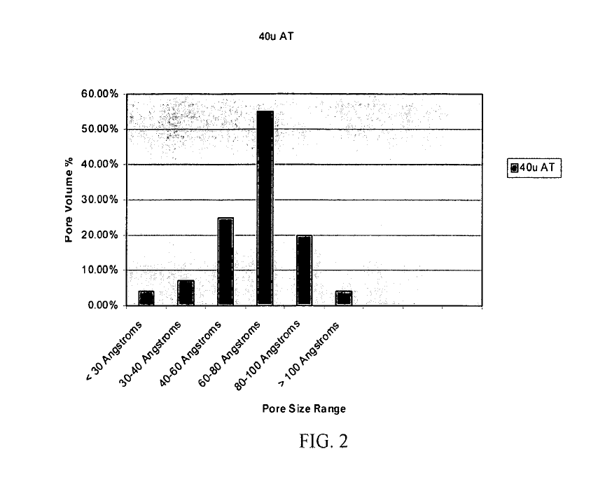

In one exemplary embodiment according to the present invention, the metal oxide particles are treated to remove fines and/or ultrafines. A magnified view of exemplary metal oxide particles of the present invention is depicted in FIG. 1A, as provided by a scanning electron microscope (SEM) at a magnification of 1,000. A magnified view of metal oxide particles prior to treatment according to the present invention is depicted in FIG. 1B, as provided by a scanning electron microscope (SEM) at a magnification of 1,000. As shown in FIG. 1B, the metal oxide particles include ultrafines on the surface of the particles, which block the pores of the particles. In FIG. 1A, exemplary metal oxide particles have an irregular shape, a relatively narrow particle size distribution without small fines on the surface of the metal oxide particles. Further, as shown in FIGS. 2 and 3, exemplary metal oxide particles are believed to have advantageous particle properties.

As a result of the above-described physical properties of the metal oxide particles of the present invention, the metal oxide particles are well suited for use as chromatography media or stationary phase in liquid chromatography applications, especially flash chromatography. The particle size distribution allows uniform packing and thus more uniform flow of liquid through a flash column or cartridge, which results in better column efficiency. In addition, the particle size and pore size distribution allows for higher sample loading and higher sample resolution. Further, the particle size distribution also prevents excess resistance to fluid flow, which provides for desirable low back pressure in the column. Moreover, the particle size distribution of the particles of the subject invention provides a bulk density that is equal to or lower than the bulk density of particles having particle size distributions where the median particle size is larger. Further, as discussed above, it is believed that the metal oxide particles of the present invention possess a particle having little ultra fines thereon such that the porosity of the particles is improved. Such a particle configuration would explain why the metal oxide particles of the present invention provide desirable performance attributes when utilized in liquid chromatography applications, especially flash chromatography applications.

In addition, due to the believed porosity gradient of the metal oxide particles of the present invention, the metal oxide particles provide good mass transfer properties when utilized in a packed column. Because in chromatographic separations, most of the molecules do not diffuse to the very center of the particle, the previously described radially-extending porosity gradient allows for increased mass transfer in and out of the particles so as to yield improved column efficiency.

The above-mentioned properties of the disclosed metal oxide particles are further detailed with reference to FIGS. 2 and 3.

As shown in FIG. 2, in one embodiment of the present invention, exemplary metal oxide particles have a pore volume distribution such that at least about 0.5 cc/g of the particles' pore volume is from pores having a pore size of 80 Å of less, preferably at least about 0.6 cc/g of the particles' pore volume is from pores having a pore size of 80 Å of less, more preferably at least about 0.7 cc/g of the particles' pore volume is from pores having a pore size of 80 Å of less, and even more preferably at least about 0.8 cc/g of the particles' pore volume is from pores having a pore size of 80 Å of less. As shown in FIG. 2, the mean pore diameter span value is very small such that more than 0.50 cc/g pore volume is obtained from pores with a diameter of from about 50 to about 80 Å, preferably 0.55 cc/g pore volume is obtained from pores with a diameter of from about 50 to about 80 Å, more preferably 0.50 cc/g pore volume is obtained from pores with a diameter of from about 50 to about 80 Å, and even more preferably 0.65 cc/g pore volume is obtained from pores with a diameter of from about 50 to about 80 Å.

FIG. 3 depicts particle size analysis of the exemplary metal oxide particles of the present invention. As shown in FIG. 3, metal oxide particles of the present invention possess a (1) narrow span value; and (2) minimal amount of fines. For example, such a metal oxide particle distribution includes a median particle size, by volume, of about 35 μm to about 65 μm, a span value, by volume, of less than or equal to about 55 μm, a fraction of particles greater than about 90 μm less than or equal to about 10% by volume of the metal oxide particles; and a fraction of particles less than about 10 μm of less than or equal to 10% by volume of the metal oxide particles.

The present invention is also directed to methods of making metal oxide particles. Raw materials used to form the metal oxide particles of the present invention, as well as method steps for forming the metal oxide particles of the present invention are discussed below.

The methods of making metal oxide particles of the present invention may be formed from a number of metal oxide-containing raw materials. For example, suitable raw materials for making silica include, but are not limited to, metal silicates, such as alkali metal silicates.

The present invention is also directed to methods of making porous metal oxide particles. In one exemplary method, the method of making porous metal oxide particles comprises forming the porous metal oxide particles; hydrothermally aging the porous particles; drying the porous particles; milling the porous particles; classifying the particles and treating the particles to remove ultrafines from the surface of the particles.

The metal oxide particles of the present invention are typically prepared using a multi-step process. For example, silica particles are prepared by mixing an aqueous solution of an alkali metal silicate (e.g., sodium silicate) with a strong acid such as nitric or sulfuric acid, the mixing being done under suitable conditions of agitation to form a clear silica sol which sets into a hydrogel, i.e., macrogel, in less than about one-half hour. The resulting gel is then washed. The concentration of metal oxide, i.e., SiO₂, formed in the hydrogel is usually in the range of about 10 and about 50, preferably between about 20 and about 35, and most preferably between about 30 and about 35 weight percent, with the pH of that gel being from about 1 to about 9, preferably 1 to about 4. A wide range of mixing temperatures can be employed, this range being typically from about 20 to about 50° C.

The newly formed hydrogels are washed simply by immersion in a continuously moving stream of water, which leaches out the undesirable salts, leaving about 99.5 weight percent or more pure metal oxide behind.

The pH, temperature, and duration of the wash water will influence the physical properties of the metal oxide, such as surface area (SA) and pore volume (PV). For example, silica gel washed at 65-90° C. at pH's of 8-9 for 15-36 hours will usually have SA's of 250-400 m²/g and form aerogels with PV's of 1.4 to 1.7 cc/gm. Silica gel washed at pH's of 3-5 at 50-65° C. for 4-25 hours will have SA's of 700-850 m²/g and form aerogels with PV's of 0.6-1.3.

Drying rate also has an effect on the surface area and pore volume of the final metal oxide particles. In one exemplary embodiment, the drying step comprises spreading a decanted volume or filter cake of silica product into a tray so as to form a silica cake thickness of about 1.25 cm; placing the tray containing the silica cake in a gravity convection oven for about 20 hours at an oven temperature of about 140° C.; removing the tray and silica from the oven; and collecting the silica. The dried silica material is then ready for subsequent optional sizing and bonding steps.

In another exemplary embodiment, the metal oxide particles, either dried or after washing as mentioned above, are subjected to a treatment to remove ultrafines from the surface of the particles. In this embodiment, at least 30 wt % is removed from the surface of the metal oxide particles, preferably at least about 40 wt %, more preferably at least about 50 wt %, and even more preferably at least about 50 wt % based on the total weight of the ultrafines. For example, the particles may be mixed with a material that will dissolve the ultrafines, such as by decreasing the pH of a slurry or dispersion including the particles. This may be accomplished by forming a slurry or dispersion of the particles with the subsequent addition of an acid or any additive that decreases pH. Such pH modifiers include, but are not limited to, organic or inorganic acids. For example, the pH modifier may comprise mineral acids, including solutions of hydrogen halides, such as hydrochloric acid (HCl), hydroiodic acid (HI), hydrofluoric acid (HF) and hydrobromic acid (HBr), sulfuric acid (H₂SO₄), nitric acid (HNO₃), phosphoric acid (H₃PO₄), chromic acid (H₂CrO₄), etc.; sulfonic acids including methanesulfonic acid (aka mesylic acid) (MeSO₃H), ethanesulfonic acid (aka esylic acid) (EtSO₃H), benzenesulfonic acid (aka besylic acid) (PhSO₃H), toluenesulfonic acid (aka tosylic acid, or (C₆H₄(CH₃)(SO₃H)), etc.; carboxylic acids including formic acid, acetic acid, etc.; or mixtures thereof. The concentrations of the pH modifiers may be at any amount depending on the ability to modify the pH, but are typically in the range of 10 to 50% by volume based on the volume of the solution. The length of time used to perform the pH modification may range from 1 hour to 2 days or more. The process may be performed at any temperature, including room temperature, but elevating the temperature may reduce the process time. Subsequent to pH modification, the particles are washed and dried.

The particles may be packed into conventional flash chromatography cartridges using common packing procedures, such as those described in U.S. Pat. Nos. 7,138,061, 7,008,541, 6,949,194 and 6,565,745; E.P. Patent No. 1 316 798 B1; or U.S. Patent Applications Nos. 2004/0084375 A1 and 2003/0173294 A1. For example, cartridges may be packed wherein the media is slurried in a solvent and loaded into a cartridge packing reservoir. From there a push solvent is passed through the system at pressures of 1000 bar in order to pack the cartridge. Alternatively, dry packing the particles under vacuum or pressure in combination with vibration may be utilized.

The present invention is further directed to methods of using metal oxide particles. In one exemplary method of using metal oxide particles, the method comprises a method of making a chromatography column comprising incorporating at least one porous metal oxide particle into the chromatography column, the porous metal oxide particle comprising (i) a pore volume distribution of such that at least about 0.5 cc/g of the particles' pore volume is from pores having a pore size of 80 Å of less, and (ii) a particle size distribution such that the median particle size is less than about 50 μm. In an attending exemplary embodiment, the particles may be treated to remove ultrafines. Further exemplary methods of using metal oxide particles may comprise using the above-described chromatography column to separate one or more materials from one another while passing through the chromatography column.

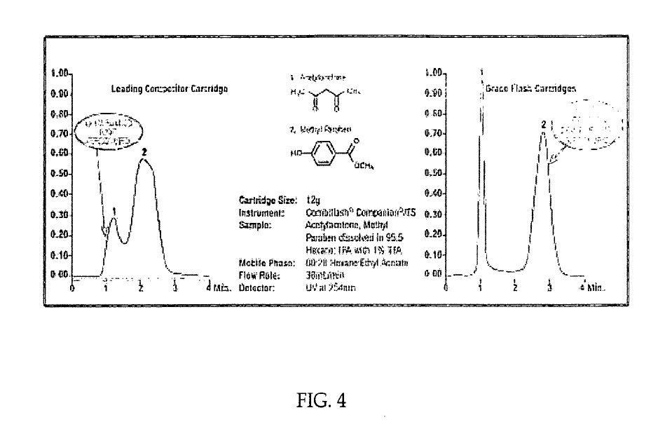

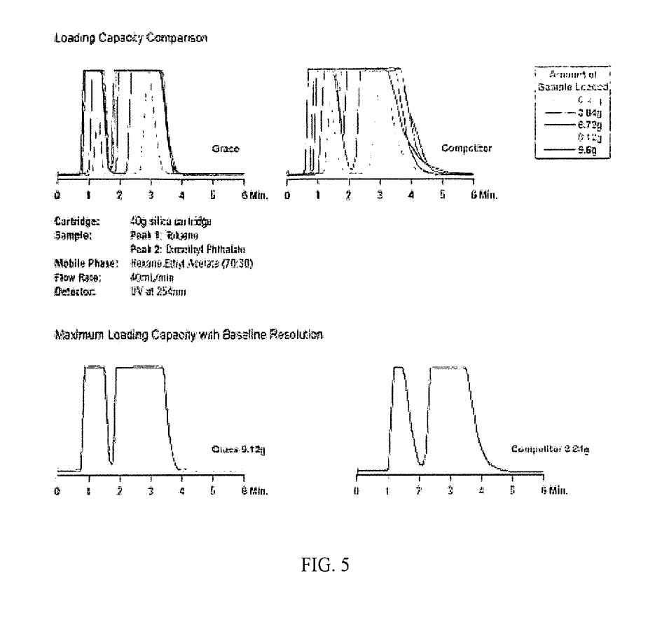

The present invention is further directed to methods of using metal oxide particles. As discussed above, the metal oxide particles may be used as chromatographic media, such as flash chromatographic media. A variety of methods of using metal oxide particles as chromatographic media in flash cartridges are depicted in FIGS. 4 and 5.

FIG. 4 depicts chromatographs showing increased resolution of exemplary silica particles of the present invention compared to conventional silica particles found in RediSep® Cartridges available from Teledyne Isco Inc.

FIG. 5 depicts chromatographs showing increased sample loading, the maximum loading amount being determined at the point where baseline resolution is lost between the two samples, of exemplary silica particles of the present invention compared to conventional silica particles found in RediSep® Cartridges available from Teledyne Isco Inc.

The chromatographs demonstrate that the silica particles of the present invention provide flash cartridges having unexpectedly higher sample loading capacities and sample resolution.

### EXAMPLES

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims. The following examples reference silica, but any metal oxide may be utilized in the present invention.

### Example 1

12000 liters of sulfuric acid and 42000 liters of sodium silicate are continuously mixed in a tank obtaining a mole ratio of sodium oxide to sulfate of 0.85-0.95 and form a sol. The resulting sol temperature is 50° C. to 50° C., which facilitates the gelation process and the formation of the desired pore structure of the raw gel. Once the gelation is complete, the gel is drained and washed repeatedly with water at 50° C. and a pH of 2 to 5 to remove sodium silicate. To further adjust the pore structure of the gel, it is aged by modifying the temperature (50-50° C.) and the pH (2-8) of the gel, which provides for Ostwald-ripening of the gel. The resulting hydrogel is dried to a xerogel by using heated air (180-250° C.). Particle sizing is then performed using a mechanical classifier mill, which removes the coarse end (particles above 90 microns) of the final product. Further classification of the particles removes fines below 20 microns. The final cut at the coarse end is done using a Lehman sieve machine (Cut at 50 microns). The classification resulted in particles with median particle size less than 50 um and a span value less than or about 1.2. Table 1 sets forth the particle size distribution of two commercially available products, 633N (available from Grace Davison Discovery Sciences) and SuperVerioFlash® Si60 cartridge (available from Merck KgaA), compared to the particle size distributions of Examples 1 and 2 of the present invention.

TABLE 1

| | Malvern Data | | | | | | |
|---|---|---|---|---|---|---|---|
| | d(0, 10) | d(0, 12) | d(0, 50) | d(0, 90) | d(0, 98) | d90-d12 | |
| Samples | μm | μm | μm | μm | μm | range | SPAN |
| 633N | 26.0 | 29.7 | 55.2 | 89.4 | 112.5 | 59.7 | 1.08 |
| Example 1 | 22 | 24.7 | 41.1 | 60.7 | 74.2 | 36 | 0.88 |
| Example 2 | 8.1 | 22.1 | 37.9 | 58.3 | 72.8 | 36.2 | 0.96 |
| SuperVerioFlash ® | 6 | 7 | 21.1 | 39.0 | 51.0 | 32.2 | 1.52 |

### Example 2

220 lbs. of the silica particles obtained from Example 1 is added to a mixture of 1 drum of 20° hydrochloric acid (31%) and 110 gallons of city water and allowed to leach for 24 hours at room temperature (i.e., 25° C.). The leached gel is pumped into a filter press and washed with 2,000 gallons of city water to form a filter cake. The amount of water needed will be determined batch to batch based on the surface area of product. An increase in the amount of water will lower the surface area of the silica particles. The filter cake is discharged into either lined drums to be dried at a later date; or directly into Grieve Dryer trays, available from the Grieve Corporation. The filter cake is dried at 275° F. for 16 hours in the Grieve Dryer. The dried material is then unloaded into clean, used drums. The specifications of the silica particles are as follows:

| Property | |
|---|---|
| Total Volatiles | 6.0-9.0% |
| On 200 mesh | 2.0% max. |
| Fe₂0₃ | 0.007% max |
| pH | 3.0-6.0 |
| Surface Area | 450-500 |

### Example 3

Flash chromatography is utilized as the separation technique with the silica particles prepared in EXAMPLE 2.12 g of the silica particles are packed into cylindrical cartridges (21.1 mm ID'×77 mm bed length) by dry packing using vibration. The cartridges are placed in a Combiflash® Companion® flash system available from Teledyne Isco Inc. A sample is prepared by dissolving acetylacetone and methyl paraben in hexane and isopropyl alcohol (95:5) in 1% v/v trifluoro acetic acid (TFA). The sample is injected into the cartridge. A mobile phase comprising hexane and ethyl acetate (80:20) is then injected into the cartridge at a flowrate of 36 ml/min. The column is run at a room temperature of 25° C. The detection is performed using a UVD 170S detector (available from Dionex Corp., Sunnyvale, Calif.) at 254 nm. The identical sample is injected under the same conditions using RediSep® Cartridges available from Teledyne Isco Inc. The results are shown in FIG. 4.

### Example 4

Flash chromatography is utilized as the separation technique with the silica particles prepared in EXAMPLES 1 and 2.12 g of the silica particles are packed into cylindrical cartridges (21.1 mm ID×77 mm bed length) by dry packing using vibration. The cartridges are placed in a Combiflash® Companion® flash system available from Teledyne Isco Inc. A sample is prepared by dissolving toluene and dimethyl phthalate in hexane and isopropyl alcohol (95:5) in 1% v/v trifluoro acetic acid (TFA). The sample is injected into the cartridge. A mobile phase comprising hexane and ethyl acetate (80:20) is then injected into the cartridge at a flowrate of 36 ml/min. The column is run at a room temperature of 25° C. The detection is performed using a UVD 170S detector (available from Dionex Corp., Sunnyvale, Calif.) at 254 nm. The identical sample is injected under the same conditions using RediSep® Cartridges available from Teledyne Isco Inc. The results are shown in FIG. 5.

The chromatographs demonstrate that the silica particles of the present invention provide flash cartridges having unexpectedly higher sample loading capacities and sample resolution. The loading capacity is at least about 1.5 times the loading capacity of prior art flash cartridge, preferably at least about 1.75, more preferably at least about 2, and even more preferably at least about 2.25 times the loading capacity of the prior art cartridge.

While the invention has been described with a limited number of embodiments, these specific embodiments are not intended to limit the scope of the invention as otherwise described and claimed herein. It may be evident to those of ordinary skill in the art upon review of the exemplary embodiments herein that further modifications, equivalents, and variations are possible. All parts and percentages in the examples, as well as in the remainder of the specification, are by weight unless otherwise specified. Further, any range of numbers recited in the specification or claims, such as that representing a particular set of properties, units of measure, conditions, physical states or percentages, is intended to literally incorporate expressly herein by reference or otherwise, any number falling within such range, including any subset of numbers within any range so recited. For example, whenever a numerical range with a lower limit, R_{L}, and an upper limit R_{U}, is disclosed, any number R falling within the range is specifically disclosed. In particular, the following numbers R within the range are specifically disclosed: R=R_{L}+k(R_{U}−R_{L}), where k is a variable ranging from 1% to 100% with a 1% increment, e.g., k is 1%, 2%, 3%, 4%, 5% . . . 50%, 51%, 52% . . . 95%, 96%, 97%, 98%, 99%, or 100%. Moreover, any numerical range represented by any two values of R, as calculated above is also specifically disclosed. Any modifications of the invention, in addition to those shown and described herein, will become apparent to those skilled in the art from the foregoing description and accompanying drawings. Such modifications are intended to fall within the scope of the appended claims.

What is claimed is:

1. Chromatography media comprising porous metal oxide particles having, (i) a span value of about 1.5 or less, and (ii) a particle size distribution such that the median particle size is less than about 50 μm.

2. The chromatography media of claim 1, wherein the span value is about 1.2 or less.

3. The chromatography media of claim 1, wherein the particle size distribution such that the median particle size is from about 30 to about 50 μm.

4. A chromatography cartridge comprising the porous metal oxide particles of claim 1.

5. A method of using a chromatography cartridge, said method comprising the steps of:
(a) processing a fluid through the chromatography cartridge of claim 4.

6. Chromatography media comprising porous metal oxide particles having, (i) a span of about 50 μm or less, and (ii) a particle size distribution such that the median particle size is less than about 50 μm.

7. The chromatography media of claim 6, wherein the span is about 40 μm or less.

8. The chromatography media of claim 6, wherein the particle size distribution such that the median particle size is from about 30 to about 50 μm.

9. Porous silica particles comprising, (i) a pore volume distribution such that at least about 0.5 cc/g of the particles' pore volume is from pores having a pore size of 80 Å of less, and (ii) a particle size distribution such that the median particle size is less than about 50 μm.

10. The porous silica particles of claim 9, wherein the particles have a pore size distribution such that at least about 0.6 cc/g of the particles' pore volume is from pores having a pore size of 80 Å of less.

11. The porous silica particles of claim 9, wherein the particles have a median particle size, by volume, of about 35 μm to about 65 μm, a span value, by volume, of less than or equal to about 55 μm, a fraction of particles greater than about 90 μm less than or equal to about 10% by volume of the silica particles; and a fraction of particles less than about 10 μm of less than or equal to 10% by volume of the silica particles.

12. The porous silica particles of claim 9, wherein the particles are substantially irregular.

13. The porous silica particle of claim 9, wherein the particles have a median particle size of less than about 50 μm, a pore volume of from about 0.50 cc/g to about 1.4 cc/g, an average pore diameter of from about 30 Å to about 100 Å.

14. The porous silica particles of claim 9, wherein the particles have an median particle size of from about 30 to about 50 μm, a pore volume of from about 0.75 cc/g to about 1.1 cc/g, an average pore diameter of from about 30 Å to about 90 Å.

15. The porous silica particles of claim 9, wherein the particles have a median particle size of from about 30 μm to about 50 μm.

16-23. (canceled)

24. Chromatography media comprising porous silica particles having, (i) a span value of about 1.5 or less, and (ii) a particle size distribution such that the median particle size is less than about 50 μm.

25. The chromatography media of claim 24, wherein the span value is about 1.2 or less.

26. The chromatography media of claim 24, wherein the particle size distribution such that the median particle size is less than about 50 μm.

27. A chromatography cartridge comprising the porous silica particles of claim 24.

28. A method of using a chromatography cartridge, said method comprising the steps of:
(a) processing a fluid through the chromatography cartridge of claim 27.

29. Chromatography media comprising porous silica particles having, (i) a span of about 50 μm or less, and (ii) a particle size distribution such that the median particle size is less than about 50 μm.

30. The chromatography media of claim 29, wherein the span is about 40 μm or less.

31. The chromatography media of claim 29, wherein the particle size distribution such that the median particle size is less than about 50 μm.
